(19) United States
(12) Patent Application Publication
(10) Pub. No.: US 2026/0210422 A1
(43) Pub. Date: Jul. 23, 2026

(54) TORQUE TRANSMISSION ASSEMBLY FOR A MOBILITY APPARATUS

(71) Applicant: VALEO EMBRAYAGES, Amiens (FR)

(72) Inventors: Eric RUMEAU, Amiens (FR); Herve MAHE, Amiens (FR); Ivan DUTIER, Amiens (FR)

(73) Assignee: VALEO EMBRAYAGES, Amiens (FR)

(21) Appl. No.: 19/142,521

(22) PCT Filed: Dec. 12, 2023
(86) PCT No.: PCT/EP2023/085365

§ 371 Date: Jul. 29, 2025

(30) Foreign Application Priority Data
Dec. 23, 2022 (FR) FR2214466

(51) Int. Cl. F16F 15/14

(52) U.S. Cl. CPC F16F 15/1457

(57) ABSTRACT

The invention relates to a transmission assembly for a mobility apparatus, said assembly comprising an electric motor comprising a rotor shaft, a speed reduction device comprising at least one transmission shaft for cooperating directly or indirectly with the rotor shaft to transmit a motor torque, and a vibration damping device for reducing vibrations, the rotor shaft or the transmission shaft forming a hollow shaft defining a cavity, the damping device being inserted into the cavity.

The invention relates to a torque transmission assembly for a mobility apparatus, such as a motor vehicle, equipped with an electric motor.

The invention concerns a transmission assembly which comprises a speed reduction device receiving a torque provided by a rotor of an electric motor.

Document DE10017396 describes a transmission assembly comprising an electric motor equipped with a stator and a rotor. The electric motor is rotationally connected to a transmission shaft via the rotor. To reduce the impact of the vibrations of the rotor on the transmission assembly, an elastic element is interposed between the rotor and the gearbox input shaft. Nevertheless, the presence of this elastic element is not entirely satisfactory and does not prevent the electric motor from being displaced, leading to curvature of the transmission assembly.

The invention aims to propose a transmission assembly for a mobility apparatus that solves the above-mentioned problems.

To this end, the subject of the invention is a transmission assembly for a mobility apparatus, said assembly comprising
an electric motor comprising a rotor shaft,
a speed reduction device comprising at least one transmission shaft capable of cooperating directly or indirectly with the rotor shaft in order to transmit a drive torque,
a vibration damping device capable of reducing vibrations,
the rotor shaft or the transmission shaft forming a hollow shaft defining a housing,
the damping device being inserted into the housing.

According to one embodiment of the invention, the damping device is tuned to a rotation frequency which is 20 to 30 times the rotation frequency of the rotor shaft.

The stiffness of the spring element is calculated in such a way that the mass does not touch the wall of the housing.

According to one embodiment, the damping device comprises a mass and a spring element, the spring element being positioned at one end so as to be fixed in terms of rotation to the rotor shaft or to the transmission shaft and cooperating at another end with the mass. Thus, the damping device advantageously forms an inertial mass damper. The mass is designed in such a way that it does not touch an inner wall delimiting the housing, even in operation.

According to one embodiment, the spring element forms a rod extending along an axis of elongation (X) of the rotor shaft or of the transmission shaft, the rod comprising a first end capable of being mounted fixedly on the rotor shaft or on the transmission shaft and a second end capable of being connected to the mass. The rod may be made of an elastic material with a predefined stiffness.

According to one embodiment, the spring element is arranged around the rotor shaft or the transmission shaft, between the rotor shaft or the transmission shaft and the mass.

According to one embodiment, the spring element forms a corrugated ring which is arranged in an annular groove formed by an inner wall of the housing. In particular, the spring element forms a corrugated ring which is arranged circumferentially with respect to the transmission shaft or the rotor shaft. The annular groove is made in such a way that the corrugated ring partially protrudes from this same groove.

In another example, there could be provided a plurality of corrugated rings distributed along the wall delimiting the housing. To do this, as many annular grooves could be provided.

According to one embodiment, the spring element forms at least one corrugated lamella arranged between the rotor shaft or the transmission shaft and the mass. According to one embodiment, the spring element forms a corrugated lamella.

According to one embodiment, this corrugated lamella forms a tube whose wall is formed of longitudinal corrugations.

According to one embodiment, longitudinal corrugation portions of the corrugated lamella are each arranged in a corresponding longitudinal groove formed by an inner wall of the housing. The longitudinal groove is made in such a way that the longitudinal corrugation portions partially protrude from this same groove.

According to one embodiment, the corrugated lamella is arranged longitudinally with respect to the rotor shaft or the transmission shaft.

According to one embodiment, the housing is closed via a closure means.

According to one embodiment, the housing is sealed. An adhesive or an element made of elastomer material may be interposed between the rotor shaft or the transmission shaft and the closure means.

According to one embodiment, the closure means is a plug mounted on the rotor shaft or on the transmission shaft by press fitting, or by screwing or by adhesive bonding on the rotor shaft or on the transmission shaft.

According to one embodiment, the mass is configured in such a way that it can define two resonance modes, a first resonance mode resulting from a radial displacement of the mass and a second resonance mode resulting from a tilting of the mass about its center of gravity. In one example, the mass forms a parallelepipedal structure of square or rectangular longitudinal section.

By convention, the “radial” orientation is directed orthogonally to the axial orientation. The axial orientation relates, depending on the context, to the axis of rotation of the shaft of the rotor and/or the axis of rotation of the transmission shaft. The “circumferential” orientation is directed orthogonally to the axial direction and orthogonally to the radial direction.

The invention will be understood better from reading the following description and examining the accompanying figures. These figures are provided only by way of entirely nonlimiting illustration of the invention.

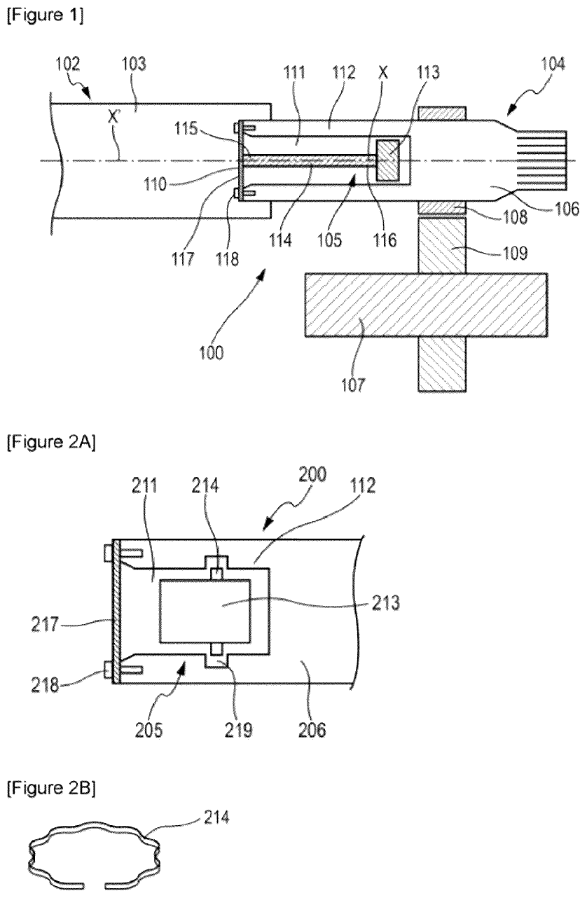

FIG. 1 is a schematic representation of a transmission assembly, according to a first example of the invention;

FIG. 2A is a schematic representation of a transmission assembly, according to a second example of the invention;

FIG. 2B is a schematic representation of a spring element, according to the second example of the invention, and

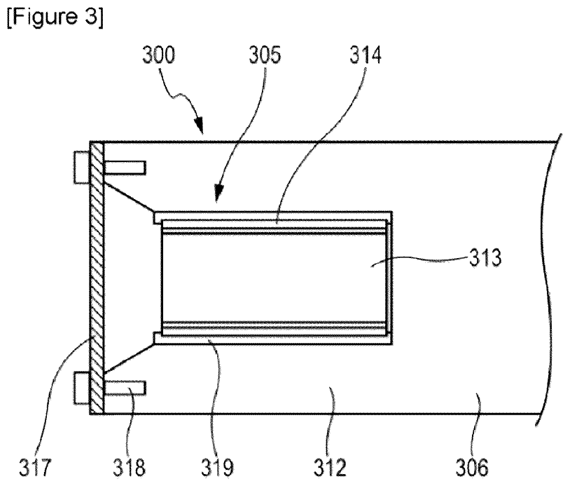

FIG. 3 is a schematic representation of a transmission assembly, according to a third example of the invention.

FIG. 1 illustrates a transmission assembly 100 for a motor vehicle of the hybrid or electric type. The transmission assembly 100 comprises an electric motor 102 comprising a rotor shaft 103, a speed reduction device 104, and a vibration damping device 105 capable of reducing vibrations. The speed reduction device 104 comprises a first transmission shaft 106 which cooperates directly with the rotor shaft 103 in order to transmit a drive torque. The speed reduction device 104 also comprises a second transmission shaft 107 which cooperates with the first transmission shaft 106. To do this, the first transmission shaft 106 and the second transmission shaft 107 respectively comprise a toothing 108 and 109 designed to cooperate with each other and to allow rotational coupling of the first transmission shaft 106 with the second transmission shaft 107.

The transmission shaft 106 has an end 110 intended to cooperate with the rotor shaft 103. At this end 110 a housing 111 is formed. This housing 111 is hollowed out longitudinally with respect to an axis of rotation or axis X of elongation of the first transmission shaft 106. This axis X of elongation is coaxial with another axis of rotation of the rotor shaft or axis X′ of elongation of the rotor shaft 103. The housing 111 is delimited by a wall 112 of the first transmission shaft 106. According to the invention, the vibration damping device 105 is inserted into the housing 111.

In particular according to this first example, the damping device 105 comprises a mass 113 and a rod 114. The rod 114 extends along the axis of elongation X of the first transmission shaft 106. The rod 114 comprises a first end 115 and a second end 116. The rod 114 is mounted fixedly on the first transmission shaft 106 by its first end 115. The mass 113 is fixed to the rod 114 by the second end 116. The rod 114 has an elastic material enabling the mass 113 to be able to tilt radially with respect to the axis X of elongation under the effect of vibrations.

The housing 111 is closed by a closure means 117. This closure means may be an insert 117 which is mounted fixedly by screwing onto the end 110 of the first transmission shaft 106 by means of screws such as 118.

A sealing means (not illustrated) may be added between the closure means and the first transmission shaft 106 in order to prevent dust or a fluid from entering the housing 111.

Other closure means may be provided, such as, for example, a plug (not illustrated) force-fitted into the first transmission shaft 106.

FIGS. 2A and 2B illustrate a second exemplary embodiment of the invention. In this example there is partially illustrated a transmission assembly 200 which comprises a transmission shaft 206, a housing 211 delimited by a wall 212, and a vibration damping device 205 arranged in the housing 211 (FIG. 2A). The damping device 205 comprises a mass 213 and a spring element 214. The mass 213 forms a parallelepipedal structure of square longitudinal section. The spring element 214 is formed by at least one corrugated ring 214 (FIG. 2B). This corrugated ring 214 is arranged circumferentially around the transmission shaft 206 along the wall 212 of the housing 211. In order to hold the corrugated ring 214 axially in position inside the housing 211, an annular groove 219 made in a thickness of the wall 212 may be advantageously provided. The mass 213 is placed in the housing 211 while being held in position by bearing elastically against the corrugated ring 214. The mass 213 is positioned inside the housing 211 in such a way that it does not touch the wall 212. The housing 211 is closed by an insert 217 by means, for example, of screws such as 218.

FIG. 3 illustrates a third exemplary embodiment of the invention. In this example there is partially illustrated a transmission assembly 300 which comprises a vibration damping device 305. This damping device 305 comprises a corrugated lamella 314 and a mass 313. This corrugated lamella 314 forms a tube whose wall is formed of longitudinal corrugations. This corrugated lamella 314 is arranged longitudinally along a wall 312 of the housing 311. In order to hold the corrugated lamella 314 axially in position inside the housing 311, there may advantageously be provision to position a circlip (not shown) at the entrance of the housing 311. In order to hold the corrugated lamella 314 circumferentially in position inside the housing 311, longitudinal grooves 319 may be provided. Thus, the corrugated lamella 314 is inserted through the housing 311 in such a way that corrugated portions (not shown) of the corrugated lamella 314 are inserted into these same grooves.

The mass 313 is placed in the housing 311 while being held in position by elastic radial bearing against the corrugated lamella 314.

The mass 313 forms a parallelepipedal structure of rectangular longitudinal section.

The housing 311 is closed by an insert 317 similar to the other two inserts 117 and 217 by means of screws such as 318.

The mass 313 is positioned inside the housing 311 in such a way that it does not touch the wall 312 or the insert 317.

1. A transmission assembly for a mobility apparatus, said assembly comprising:
an electric motor comprising a rotor shaft
a speed reduction device comprising at least one transmission shaft capable of cooperating directly or indirectly with the rotor shaft in order to transmit a drive torque,
a vibration damping device capable of reducing vibrations,
the rotor shaft or the transmission shaft forming a hollow shaft defining a housing. the damping device being inserted into the housing.

2. The transmission assembly as claimed in claim 1, wherein the damping device comprises a mass and a spring element the spring element being positioned at one end so as to be fixed in terms of rotation to the rotor shaft or to the transmission shaft and cooperating at another end with the mass.

3. The transmission assembly as claimed in claim 2, wherein the spring element forms a rod extending along an axis of elongation of the rotor shaft or of the transmission shaft, the rod comprising a first end capable of being mounted fixedly on the rotor shaft or on the transmission shaft and a second end capable of being connected to the mass.

4. The transmission assembly as claimed in claim 2, wherein the spring element is arranged around the rotor shaft or the transmission shaft, between the rotor shaft or the transmission shaft and the mass.

5. The transmission assembly as claimed in claim 4, wherein the spring element forms a corrugated ring which is arranged in an annular groove formed by an inner wall of the housing.

6. The transmission assembly as claimed in claim 4, wherein the spring element forms a corrugated lamella, this corrugated lamella forming a tube whose wall is formed of longitudinal corrugations.

7. The transmission assembly as claimed in claim 6, wherein longitudinal corrugation portions of the corrugated lamella are each arranged in a corresponding longitudinal groove formed by an inner wall of the housing.

8. The transmission assembly as claimed in claim 1, wherein the housing is closed via a closure means

9. The transmission assembly as claimed in claim 1, wherein the housing is sealed.

10. The transmission assembly as claimed in claim 8, wherein the closure means is a plug mounted on the rotor shaft or on the transmission shaft by press fitting, or by screwing or by adhesive bonding on the rotor shaft or on the transmission shaft.
